(19) United States
(12) Patent Application Publication
(10) Pub. No.: US 2006/0169396 A1
(43) Pub. Date: Aug. 3, 2006

(54) Method for producing a three-dimensional preform

(76) Inventor: Paul Joern, Hamburg (DE)

Correspondence Address: MARSHALL & MELHORN, FOUR SEAGATE, EIGHT FLOOR, TOLEDO, OH, 43604, US

(21) Appl. No.: 10/533,606

(22) PCT Filed: Oct. 29, 2003
(86) PCT No.: PCT/EP03/12014

§ 371 Date: Dec. 14, 2005

(30) Foreign Application Priority Data
Oct. 31, 2002 (DE) 102 50 826.7

(51) Int. Cl. B32B 29/02

(52) U.S. Cl. 156/166; 156/176

(57) ABSTRACT

This invention relates to a method for the production of a producing a three-dimensional preform from textile starting materials such as fibers, fiber bundles or tapes. The textile starting materials are laid in a plane in a two-dimensional manner, whereby the orientation of the fibers and the geometry of the two-dimensional bonded fabric have been determined from the three-dimensional target form by means of back-calculation. The three-dimensional target form is produced by shaping/draping the two-dimensional bonded fabric.

This invention relates to a method for producing a three-dimensional preform, whereby in a first step, a two-dimensional bonded fabric is produced in a plane and then a shaping/draping process is performed to produce the three-dimensional target form.

Various textile products, which are also referred to as semi-finished products, are used In the production of fiber-reinforced plastics. In addition to woven fabrics and braided fabrics, bonded fabrics and other textile structures can also be used. Then these semi-finished products are cut to size and fabricated using various processes wherein they are combined and connected with one another. The resulting preforms are finally saturated with a matrix system and are generally cured under elevated pressure and at an elevated temperature.

The fixing of the preforms can be done by means of a binder, the matrix system or a mechanical fixing, e.g. sewing. The binder systems used are primarily thermoplastic substances that are applied, e.g. in powder form, to the semifinished product and are activated by the effect of temperature. In addition to a definition of the fiber orientation, the binder systems can also be used to fix the preforms in a compacted state.

Fabricated textile materials such as, for example, multiaxial bonded fabric and braided fabric, for example, are currently used for to the production of fiber-reinforced high-performance plastics, from which a preform is made by cutting and draping processes. Most of these semi-finished products are not produced so that they are optimized for a specific component. The consequences of this approach include incorrect or undesired fiber orientations and additional disadvantages, such as overlaps, for example. There are also methods with which component-specific preforms can be produced from individual fiber bundles (rovings). These fabrication methods include, among others, winding, (tailored) fiber placement, tape-laying and tow placement. The winding, tow placement and (tailored) fiber placement methods can be used in particular for the production of complex preforms with a targeted fiber orientation. The winding and tow placement methods are particularly well suited for complex three-dimensional structures.

In fiber lapping, fiber semi-finished products are wound onto a rotating core. The laying angle can be define by the position of the fiber carrier (thread eyelet). Normally, the semi-finished product used is one or more dry rovings which are soaked in a tempered matrix bath immediately before the winding process (wet winding), although pre-impregnated prepreg rovings can also be used (prepreg method). Consequently, prepreg fiber semi-finished products can be processed more easily and better laminate qualities can be achieved. An additional method is dry winding.. The subsequent impregnation of previously dry-wound components can be realized with different injection methods. The component is cured directly on the core. The winding bodies can be lost cores, separable cores or flexible, inflatable cores.

The fabrication of complex components is possible, of course, although it is practically impossible to introduce targeted reinforcements because the fibers are always being deposited over a larger circumference. Winding machines that work in six or more axes allow the designer to precisely define the position and orientation of the thread eyelet. The fiber feed can thereby occur along the x, y or z axis and makes it possible to rotate the thread eyelet around the three orthogonal axes, so that even bodies that are not rotationally symmetrical, such as, for example, carriers in the shape of a “T” can be produced. The principal application of the winding technique is the production of cylindrical components (e.g. lines, structures, rods etc.) and containers (pressure vessels etc.). Larger components can also be manufactured, such as, for example, tubes with diameters greater than 10 m.

If a thermoplastic material is used as the matrix material or as the binder, the semi-finished product is heated together with the resin and cooled after it has been laid on the core. On account of these methods, the laying speeds are slower than with duroplastic resins.

The laying of narrow individual fibers, as well as fiber placement, is an additional production method that is especially well suited for the production of complex curved components. The pre-impregnated fibers are thereby transported individually to the laying head, where they are combined into a narrow fiber band and laid on the component. Instead of a resin system, a binder can also be used for fixing, so that the result is a dry preform which is only subsequently injected with resin.

In some methods, particularly narrow tapes (width<3 mm) or fiber bundles (which are also called “tow”) are used. These methods are therefore designated tow-placement methods. They have a great deal of flexibility, because the fibers can be cut individually and laid as desired. With commercially available plants, between 1 and 32 tows can be laid simultaneously. It is thereby possible to lay fibers on complex three-dimensional geometries and to realize targeted reinforcements. Draping, which occurs during a tape-laying process with radii that are too small, can be reduced to a certain extent by the adaptation of the individual tows. For this purpose it is necessary to control the compacting and the cutting of the individual tows separately, in addition to the individual laying speed.

The two methods described above have the disadvantage that certain preform geometries and fiber orientations cannot be realized. The tow placement method is more flexible, of course, although it is also restricted on account of, among other things, the low laying speeds on complex three-dimensional geometries and for the production of small radii. For the production of preforms with complex geometries and fiber orientations with tow placement, very expensive equipment (e.g. laying robots) is required, which drives the price of the component upward, in spite of the fact that only low laying speeds are achieved.

For the production of multiaxial joints, individual rovings are also laid at a defined angle. This is a process that of course has a high mass flow rate, but allows only the production of flat semi-finished products with a constant and continuous fiber orientation. If multiaxial joints are used in the construction of three-dimensional preforms by draping, the fiber angles within the bonded fabric also change. Normally, this change of angle is not desirable and is not optimally coordinated to the preform or the three-dimensional component.

Starting from this prior art, the object of this invention is therefore to indicate a method in which a fabrication process that is adapted to the component can be used for three-dimensional, fiber-reinforced components, whereby complex three-dimensional geometries, an optimal fiber orientation and a high laying rate can be achieved with relatively little expense in terms of equipment.

The invention teaches that this object can be accomplished by the characteristics disclosed in Claim 1. The subclaims disclose advantageous developments of the invention.

The invention therefore teaches a fabric production process, i.e. a process for the production of a two-dimensional flat fiberwoven fabric, to be combined with a shaping process. In the method taught by the invention, the orientation and the geometry of the textile starting materials for the two-dimensional bonded fabric lying in a plane are determined by back-calculation from the three-dimensional target shape. The new method therefore utilizes the fact that at the end of the fabric production textile process (Method Step a)), the fibers are not yet definitively fixed in position. At this point, the fibers, which are still movable, are placed in the desired orientation and geometry by shaping/draping.

For the first time, therefore, a method is available in which the three-dimensional target shape has exactly the fiber orientation and geometry that are required by the preform. An additional important advantage of the method taught by the invention is that as a result of the formation of the two-dimensional bonded fabric lying in a plane, a high laying speed can be achieved, and the cost of the equipment is thereby minimized. The flat production of the preform is thereby adapted to the component, so that the desired fiber orientation and geometry are achieved during the subsequent shaping/draping. Before the laying process, it is therefore necessary to calculate the fiber orientation and the geometry of the flat preform so that the required fiber orientation and geometry are achieved after the shaping/draping process. These calculations are in themselves known and are described in the prior art. The production method described by the invention is therefore a preform production process which is targeted toward a later three-dimensional contour which is achieved by shaping/draping. This orientation and the shaping of the textile starting materials can thereby be achieved by an intermediate backing and various shaping tools with a suitable geometry. The method taught by the invention can naturally be carried out with all the starting materials known from the prior art, e.g. with fibers, fiber bundles or tapes.

The fixing of the fibers can be realized with all measures known from the prior art. On one hand, a mechanical fixing is possible, e.g. by means of pins, clamping elements, adhesive strips or brushes, or a chemical fixing by means of binders. It is also possible to work with pre-impregnated textile materials.

The fixing can thereby take place before, during or after the shaping/draping process.

The laying of the preform into the two-dimensional fabric lying in a plane is possible using different methods, e.g. by winding around pins or with other fixing aids, by two-placement, fiber placement (prepreg or binder) and by laying dry fibers and sewing.

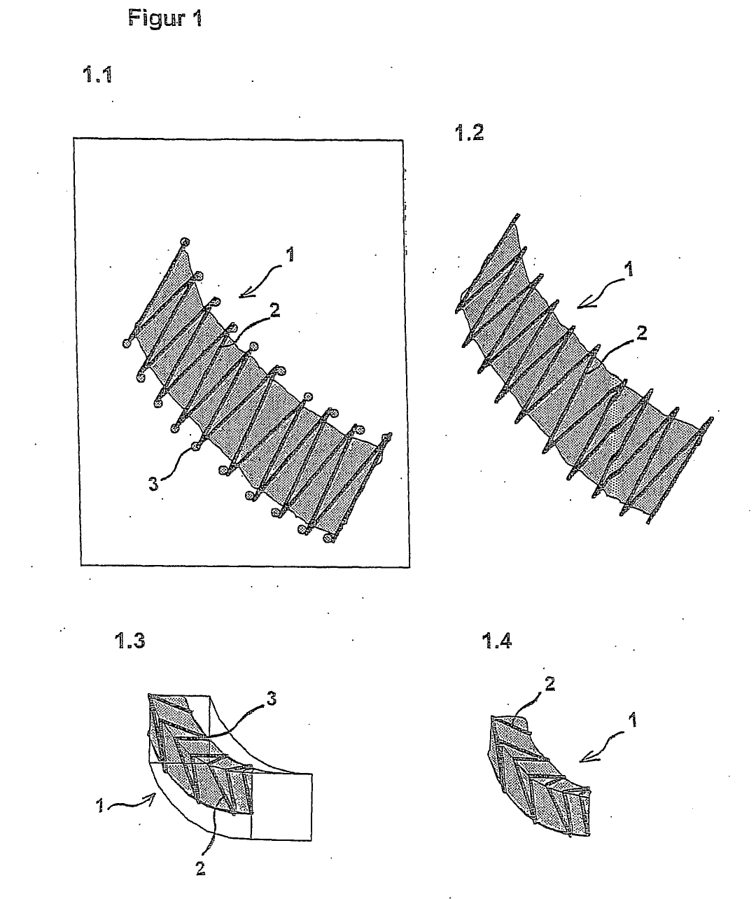

The invention is explained in greater detail below with reference to the accompanying FIG. 1.

FIG. 1 shows schematically the sequence of operations of the method claimed by the invention. FIG. 1.1 shows, by way of example, the laying of the preform 1 and the individual fiber orientations. The fibers 2 are thereby fixed by means of pins, clamp elements, adhesive strips or brushes 3. Both rovings and fiber bundles can be used as the textile starting material.

In the exemplary embodiment illustrated in FIG. 1, as can be discerned from FIG. 1.2, after the formation of the two-dimensional bonded fiber, the preform 1 is removed and cut to size, if necessary. It is essential, in the method claimed by the invention, that there is a flat preform, whereby the path of the fibers and the geometry has been calculated in advance. The calculated fiber geometry and the orientation are thereby determined by back-calculation from the final three-dimensional target shape of the preform.

After the removal of the preform, and cutting to size if necessary, the preform is then subjected to a shaping/draping process (1.3). The fiber path that has thereby been produced corresponds exactly to the path of the fiber as it is supposed to be in the target preform.

After the execution of the shaping process, the preform is then removed and cut to size if necessary (1.4).

1. Method for the production of a three-dimensional preform from textile starting materials such as fibers, fiber bundles or tapes, characterized in that
a) the textile starting materials are laid two-dimensionally in a plane, whereby the orientation of the fibers and the geometry of the two-dimensional bonded fiber has been back-calculated from the three-dimensional target form,
b) the three-dimensional target form is produced by shaping/draping of the two-dimensional bonded fiber.

2. Method as claimed in claim 1, characterized in that after Step b), a compacting is performed.

3. Method as claimed in claim 1 or 2, characterized in that fibers, fiber bundles or tapes are used as textile starting materials.

4. Method as claimed in at least one of the claims 1 to 3, characterized in that mechanical fixing means and/or a binder are used for fixing.

5. Method as claimed in claim 4, characterized in that pins, clamp elements, adhesive strips or brushes are used as fixing means.

6. Method as claimed in claim 4, characterized in that the textile starting materials are fixed by sewing.

7. Method as claimed in claim 4, characterized in that the textile starting materials are fixed by the introduction of a binder before, during or after the shaping/draping process.

8. Method as claimed in at least one of the claims 1 to 7, characterized in that pre-impregnated textile materials such as fibers or fiber bundles are used as textile starting materials.

9. Method as claimed in at least one of the claims 1 to 8, characterized in that after Step a) of the method, the two-dimensional bonded fabric is removed and cut to size if necessary and fed to the three-dimensional shaping/draping process.

10. Method as claimed in at least one of the claims 1 to 9, characterized in that, after Step b) of the method, the three-dimensional preform is cut to size.
